(19) United States
(12) Patent Application Publication
(10) Pub. No.: US 2026/0368393 A1
(43) Pub. Date: Nov. 19, 2026

(54) MULTILAYER FILM DESIGN APPARATUS, METHOD, AND STORAGE MEDIUM

(71) Applicant: KABUSHIKI KAISHA TOSHIBA, Kawasaki-shi Kanagawa (JP)

(72) Inventor: Shuhei Nitta, Tokyo (JP)

(73) Assignee: KABUSHIKI KAISHA TOSHIBA, Kawasaki-shi Kanagawa (JP)

(21) Appl. No.: 19/466,877

(22) Filed: Feb. 2, 2026

(30) Foreign Application Priority Data
May 13, 2025 (JP) 2025-080688

(51) Int. Cl. G06F 30/20; G06F 30/10; G06F 111/06; G06F 119/06

(52) U.S. Cl. CPC G06F 30/20; G06F 30/10; G06F 2111/06; G06F 2119/06

(57) ABSTRACT

According to one embodiment, a multilayer film design apparatus includes a processor. The processor dimensionally compresses a plurality of refractive index spectra representing refractive indexes for respective wavelengths corresponding to a plurality of composition candidates. The processor searches, for each layer constituting a multilayer film, a combination of a composition and a thickness over the layers that maximizes photovoltaic power as an optimal multilayer film structure using a search parameter space. The search parameter space includes, as search parameters, a position of a low-dimensional space in which a plurality of points corresponding to the refractive index spectra after dimensional compression is distributed and a thickness of each layer.

### CROSS-REFERENCE TO RELATED APPLICATIONS

This application is based upon and claims the benefit of priority from Japanese Patent Application No. 2025-080688, filed May 13, 2025, the entire contents of which are incorporated herein by reference.

### FIELD

Embodiments described herein relate generally to a multilayer film design apparatus, a method, and a storage medium

### BACKGROUND

A multilayer film structure provided above and below a substrate of a solar cell has been designed. In an example, the multilayer film structure is designed manually based on characteristics of light and experience. In the optical simulation described in Non-patent Literature 1 (Steven J. Byrnes, “Multilayer optical calculations”, Arxiv1603.02720, 2020), when the refractive index spectrum and the thickness of the composition of each layer are determined, the photovoltaic power can be estimated by assuming the solar spectrum and the conversion efficiency of the solar cell.

The search parameters related to the design of the multilayer film structure include the number of layers, the composition of each layer, and the thickness of each layer. Since the dimension of the search parameter is large and manual design is difficult, it is required to search for an optimal parameter using artificial intelligence (AI). However, the composition is required to be selected from a plurality of candidates and searched for, as compared with the thickness that can be searched for with a continuous value. In general, compared to a search of the continuous value, a search of category selection often leads to a decrease in search efficiency and a decrease in final performance (for example, estimation of photovoltaic power in the searched multilayer film design).

### BRIEF DESCRIPTION OF THE DRAWINGS

FIG. 1 is a diagram illustrating a configuration example of a multilayer film design apparatus according to the present embodiment.

FIG. 2 is a diagram illustrating a processing example related to design of a multilayer film structure by the processor illustrated in FIG. 1.

FIG. 3 is a diagram schematically illustrating a search space related to a multilayer film structure.

FIG. 4 is a diagram illustrating an example of a refractive index spectrum.

FIG. 5 is a diagram illustrating a distribution of a first principal component of a refractive index spectrum after dimensional compression by principal component analysis.

FIG. 6 is a diagram illustrating a continuous value range of a thickness.

FIG. 7 is a diagram illustrating a processing example related to optimization of a multilayer film structure by a search unit.

FIG. 8 is a diagram schematically showing a first identification method of identifying a composition.

FIG. 9 is a diagram schematically showing a second identification method of identifying a composition.

FIG. 10 is a diagram illustrating an example of a schematic diagram of a multilayer film representing an optimal multilayer film structure.

FIG. 11 is a diagram illustrating another example of a schematic diagram of a multilayer film representing an optimal multilayer film structure.

FIG. 12 is a diagram illustrating a low-dimensional space according to the second modification.

FIG. 13 is a diagram schematically illustrating resetting of a search parameter space according to the fourth modification.

FIG. 14 is a diagram schematically illustrating a processing example related to design of a multilayer film structure according to the fifth modification.

### DETAILED DESCRIPTION

A multilayer film design apparatus according to an embodiment includes a compression unit and a search unit. The compression unit dimensionally compresses a plurality of refractive index spectra representing refractive indexes for respective wavelengths corresponding to a plurality of composition candidates. The search unit searches for a combination of a composition and a thickness over the plurality of layers that maximizes photovoltaic power as an optimal multilayer film structure using a search parameter space. The search parameter space includes, as search parameters, a position of a low-dimensional space in which a plurality of points corresponding to the plurality of refractive index spectra after dimensional compression is distributed and a thickness of each layer.

Hereinafter, a multilayer film design apparatus, a method, and a storage medium according to the present embodiment will be described with reference to the drawings.

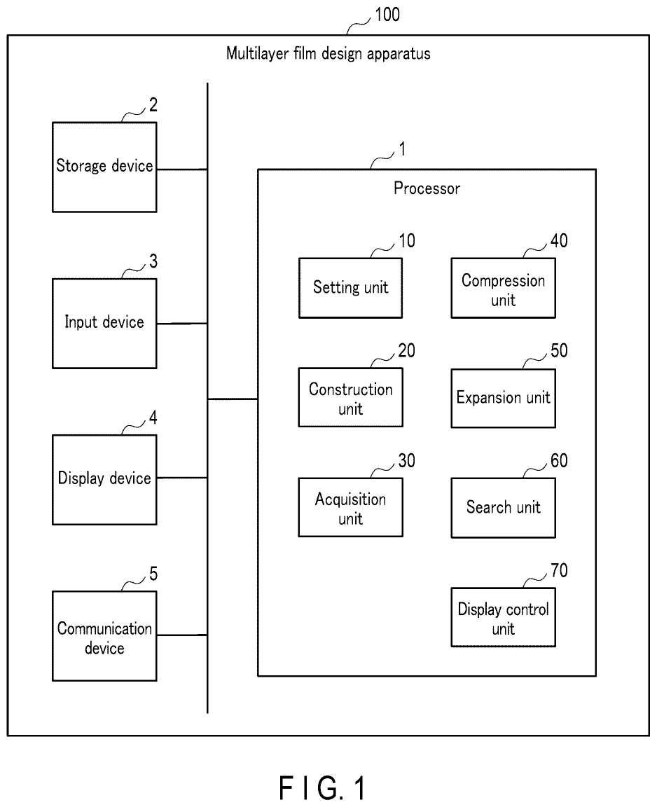

FIG. 1 is a diagram illustrating a configuration example of a multilayer film design apparatus 100 according to the present embodiment. As illustrated in FIG. 1, the multilayer film design apparatus 100 includes a processor 1, a storage device 2, an input device 3, a display device 4, and a communication device 5. Transmission and reception of data and various signals of the processor 1, the storage device 2, the input device 3, the display device 4, and the communication device 5 are performed via a bus.

The processor 1 is an integrated circuit that controls the entire operation of the multilayer film design apparatus 100. For example, the processor 1 includes a central processing unit (CPU), a graphics processing unit (GPU), a digital signal processor (DSP), and/or a floating-point unit (FPU). The processor 1 may include an internal memory or an I/O interface. The processor 1 executes various processes by interpreting and calculating a program stored in advance by the storage device 2 or the like. Part or the whole of the processor 1 may be realized by hardware such as an application specific integrated circuit (ASIC) or a field programmable gate array (FPGA).

The storage device 2 is a volatile memory and/or a nonvolatile memory that stores various pieces of data. For example, the storage device 2 stores data and setting values used in a case where the processor 1 executes various processes, data generated by various processes in the processor 1, and the like. The storage device 2 includes a read only memory (ROM), a random access memory (RAM), a hard disk drive (HDD), a solid state drive (SSD), an integrated circuit storage apparatus, and the like. Note that the storage device 2 may include a non-transitory computer-readable storage medium that stores a program executed by the processor 1.

The input device 3 receives inputs of various operations from an operator. As the input device 3, a keyboard, a mouse, various switches, a touch pad, a touch panel display, and the like can be used. An operation signal that is an electric signal corresponding to the input of the received operation is supplied to the processor 1.

The display device 4 displays various pieces of data under the control of the processor 1. As the display device 4, a cathode-ray tube (CRT) display, a liquid crystal display, an organic electro luminescence (EL) display, a light-emitting diode (LED) display, a plasma display, or any other display can be appropriately used. The display device 4 may be a projector.

The communication device 5 includes a communication interface such as a network interface card (NIC) for performing data communication with various devices connected to the multilayer film design apparatus 100 via a network. Note that an operation signal may be supplied from a computer connected via the communication device 5 or an input device included in the computer, or various pieces of data may be displayed on a display device or the like included in the computer connected via the communication device 5. However, in order to simplify the following description, unless otherwise specified, it is assumed that the supply source of the operation signal is the input device 3 and the display destination of various pieces of data is the display device 4. The input device 3 can be replaced with a computer connected via the communication device 5 or an input device included in the computer, and the display device 4 can be replaced with a display device or the like included in the computer connected via the communication device 5.

The multilayer film design apparatus 100 does not need to include all of the processor 1, the storage device 2, the input device 3, the display device 4, and the communication device 5. When necessary, some of the storage device 2, the input device 3, the display device 4, and the communication device 5 may not be provided. The multilayer film design apparatus 100 may include any additional hardware device useful for executing the processing according to the present embodiment. The multilayer film design apparatus 100 does not need to be physically configured by one computer, and may be configured by a computer system including a plurality of computers communicably connected via a wired or network line or the like. The allocation of the series of processes according to the present embodiment to the plurality of processors 1 mounted on the plurality of computers can be set in any manner. All the processors 1 may execute all the processes in parallel, or a specific process may be assigned to one or some of the processors 1, and a series of processes according to the present embodiment may be executed as the entire computer system.

The processor 1 optimizes the structure of the multilayer film. As the multilayer film according to the present embodiment, a multilayer film stacked on a silicon power generation layer included in a solar cell is assumed. The solar cell according to the present embodiment is assumed to be a tandem type solar cell including both a silicon power generation layer and a power generation layer having another composition in the power generation layer. In designing a multilayer film structure related to a solar cell, it is required to appropriately control reflection and transmission. For example, in a tandem solar cell in which two or more solar cells are disposed in series and each of the solar cells effectively uses sunlight by absorbing wavelengths of light that respective solar cells can handle, it is necessary to design each solar cell so as to absorb wavelengths of light, as much as possible, that respective solar cells can handle while suppressing reflection.

As illustrated in FIG. 1, the processor 1 includes a setting unit 10, a construction unit 20, an acquisition unit 30, a compression unit 40, an expansion unit 50, a search unit 60, and a display control unit 70.

The setting unit 10 sets a search space that defines a composition candidate and a thickness of each layer included in the multilayer film, and a search parameter space that defines a composition candidate and a thickness of each layer included in the multilayer film in a continuous value multidimensional space. The construction unit 20 constructs a composition database (hereinafter, composition DB) in which a plurality of composition candidates and a plurality of refractive index spectra are associated with each other. The refractive index spectrum is data representing a refractive index for each wavelength. The acquisition unit 30 acquires the search space, the search parameter space, and/or the composition DB. The compression unit 40 dimensionally compresses the plurality of refractive index spectra. Since the space in which the plurality of refractive index spectra after the dimensional compression is distributed is lower in dimension than the space in which the plurality of refractive index spectra is distributed, the space is referred to as a low-dimensional space. The expansion unit 50 calculates a refractive index spectrum (hereinafter, the estimated refractive index spectrum) by performing inverse transform of dimensional compression on a position in the low-dimensional space. The search unit 60 searches for an optimal multilayer film structure using the search parameter space. The display control unit 70 displays the optimal multilayer film structure and the like on the display device 4.

Hereinafter, the design of the multilayer film structure will be described in detail. In the following description, it is assumed that the processor 1 designs a multilayer film structure of a tandem solar cell.

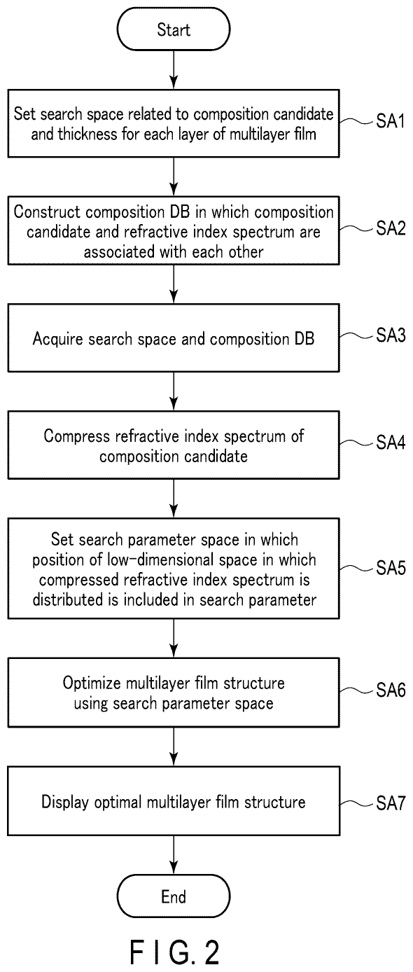

FIG. 2 is a diagram illustrating a processing example related to the design of the multilayer film structure by the processor 1. As illustrated in FIG. 2, the setting unit 10 sets a search space related to the multilayer film structure (step SA1). The search space defines a layer (hereinafter, search target layer) for which a composition candidate (hereinafter, composition candidates) and/or a thickness are searched for among a plurality of layers included in the multilayer film, and a search target (composition candidate and/or thickness) in each search target layer.

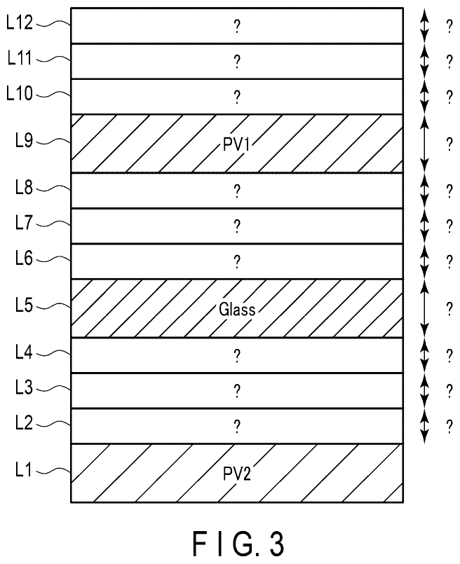

FIG. 3 is a diagram schematically illustrating a search space related to a multilayer film structure. The multilayer film structure shown in FIG. 3 relates to a tandem solar cell having 12 layers of L1 to L12. As an example, the first layer L1 is an non-transmissive bottom solar cell layer (PV2), the fifth layer L5 is a glass layer for mounting (Glass), and the ninth layer 19 is set as a transmissive top solar cell layer (PV1). Three thin films are initially set on each of the layers L1, L5, and L9.

For the first layer L1, the composition and the thickness of the bottom solar cell layer (PV2) are fixed. That is, the first layer L1 is not the search target layer. The composition of the fifth layer L5 is fixed to glass, and the thickness is searched for. In the ninth layer L9, the composition of the top solar cell layer (PV1) is fixed, and the thickness is searched for. Both the composition and the thickness of the second to fourth layers L2 to L4, the sixth to eighth layers L6 to L8, and the tenth to twelfth layers L10 to L12 are searched for. The second to twelfth layers L2 to L12 are set as the search target layers. “?” in FIG. 3 means a search target.

In the present embodiment, the following symbols are used.
L is the number of layers. In the case of the present embodiment, L=11.
{m₁, m₂, . . . , m_{L}}: mₗ is an index (1 to M) indicating the type of composition of the l-th layer.
M is the number of composition types
m₄=composition index of PV1
m₈=composition index of glass
{d₁, d₂, . . . , d_{L}}: dₗ is a thickness of the l-th layer [nm]

The setting unit 10 sets a search target layer and a search target manually by an operator via the input device 3 or automatically according to a predetermined rule. Note that the number of layers of the search target layer can be set in any number. Note that the number of layers may be set as the search target. The number of layers can be optimized by allowing the thickness to be zero. The data of the set search space is stored in the storage device 2.

When step SA1 is performed, the construction unit 20 constructs a composition DB in which a plurality of composition candidates and a plurality of refractive index spectra are associated with each other (step SA2). Specifically, the construction unit 20 first selects a composition candidate that can be used for the thin film, extracts data of a refractive index spectrum regarding the selected composition candidate from the refractive index dictionary, and associates a category value of the composition candidate with data of the refractive index spectrum in the composition DB. Thus, the composition DB is constructed. Data of the composition DB is stored in the storage device 2.

As the composition candidate contained in the composition DB, any composition that can be used for the thin film may be selected. The composition candidate is not particularly limited, but any material such as Si, MgF₂, AZO, Cu₂O, SiO₂, ATO, Ai₂O₃, ZrO₂, TiO₂, and GaO can be applied. As the category value, a name, a code, or the like of the composition candidate can be used. For example, the refractive index dictionary assumes a database that stores data of refractive index spectra of various compositions. The refractive index dictionary is managed by an external computer accessible to the multilayer film design apparatus 100 via the communication device 5.

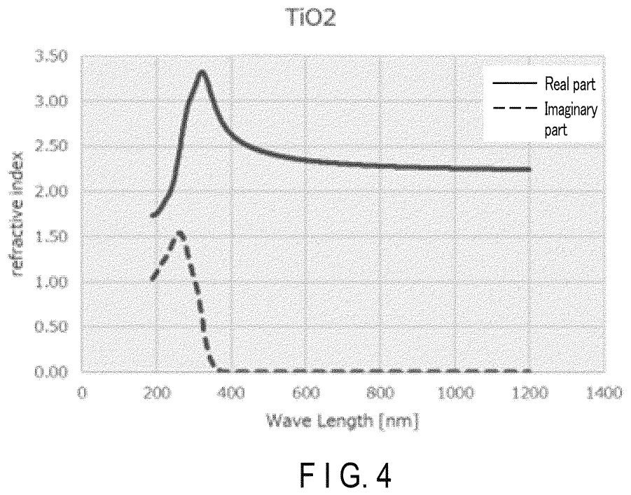

FIG. 4 is a diagram illustrating an example of a refractive index spectrum, and illustrates a refractive index spectrum of titanium oxide TiO₂ as an example. In FIG. 4, the horizontal axis represents a wavelength [nm], and the vertical axis represents a refractive index. The refractive index is a complex number, and a solid line represents a real part and a broken line represents an imaginary part. The wavelength is defined by discrete values. In the present embodiment, the refractive index is defined in increments of 1 nm from 300 nm to 1200 nm. That is, the refractive index spectrum of a certain composition is regarded as a 901 dimensional complex vector.

For the sake of simplicity, the refractive index spectrum according to the present embodiment is represented by an 1802 dimensional real number vector in which a real part and an imaginary part are disposed in one row. In the composition DB, the refractive index spectrum is held by the number M of composition candidates of the thin film. That is, the refractive index spectrum held in the composition DB is expressed as {n₁, n₂, . . . , n_{M}}. nₘ is an 1802 dimensional real number vector representing the refractive index spectrum of the m-th composition candidate.

When step SA3 is performed, the acquisition unit 30 acquires the search space set in step SA1 and the composition DB constructed in step SA2 (step SA3). As an example, the acquisition unit 30 reads the data of the search space and the data of the composition DB from the storage device 2.

When step SA3 is performed, the compression unit 40 dimensionally compresses a plurality of refractive index spectra representing refractive indexes for respective wavelengths corresponding to the plurality of composition candidates (step SA4). As described above, in the present embodiment, the refractive index spectrum is expressed by an 1802 dimensional real number vector. The compression unit 40 performs dimensional compression by performing principal component analysis on a set {n₁, n₂, . . . , n_{M}} of a plurality of refractive index spectra included in the composition DB. A space in which a plurality of refractive index spectra after dimensional compression is distributed is referred to as a low-dimensional space. In the present embodiment, the dimension of the low-dimensional space is not particularly limited as long as it is lower than the 1802 dimension which is the dimension of the refractive index spectrum. However, in the following description, it is assumed that the low-dimensional space is one-dimensional corresponding to the dimension of the first principal component of the refractive index spectrum after the dimensional compression. A point corresponding to the refractive index spectrum after the dimensional compression distributed in the low-dimensional space is referred to as a corresponding point.

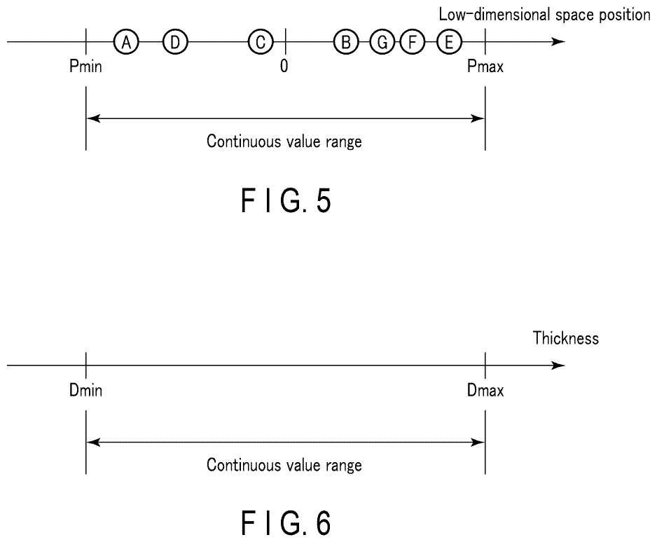

FIG. 5 is a diagram illustrating a distribution of a first principal component of a refractive index spectrum after dimensional compression by principal component analysis. For M=7 kinds of composition candidates (A, B, C, D, E, F, G), the first principal component after dimensional compression by the principal component analysis is mapped in a low-dimensional space which is a one-dimensional continuous value space. A point representing the first principal component means a corresponding point. As shown in FIG. 5, the relationship between seven kinds of compositions can be evaluated in a continuous space, and a plurality of composition candidates can be treated as a continuous value. The position in the low-dimensional space is used by the search unit 60 as a search parameter for searching for the type of composition.

When step SA4 is performed, the setting unit 10 sets the search parameter space in which the position of the low-dimensional space in which the compressed refractive index spectrum is distributed is included in the search parameter (step SA5). More specifically, the setting unit 10 sets the search parameter space including the continuous value range of the low-dimensional space and/or the continuous value range of the thickness. In other words, the setting unit 10 sets the search parameter space in which the low-dimensional space position and the thickness are included in the search parameters. The search parameter space has dimensions corresponding to the number of layers for which the type of composition is searched for and the number of layers for which the thickness is searched for. As illustrated in FIG. 3, the search parameter space according to the present embodiment has a 20 dimension obtained by combining 11 layers for which the thickness is searched for and 9 layers for which the type of composition is searched for.

As illustrated in FIG. 5, the low-dimensional space position is a continuous value, and its value range is set in a range from a minimum value Pmin to Pmax. For example, a continuous value range from Pmin=−10 to Pmax=+10 is set as the search range of the composition type, that is, the low-dimensional space position. Pmin and Pmax can be set to any value by an operator via the input device 3 or automatically according to a predetermined algorithm.

FIG. 6 is a diagram illustrating a continuous value range of the thickness. As shown in FIG. 6, the thickness is a continuous value, and the value range thereof is set in a range from the minimum value Dmin to Dmax. For example, a continuous value range from Dmin=1 to Dmax=30 is set as the search range of the thickness. Dmin and Dmax can be set to any values by an operator via the input device 3 or automatically according to a predetermined algorithm. By including a zero value in the continuous value range of the thickness, it is possible to realize a solution for eliminating the layer. In this case, for example, Dmin=0 is set.

When step SA5 is performed, the search unit 60 optimizes the multilayer film structure using the search parameter space (step SA6). In step SA6, the search unit 60 searches the combination of the composition and the thickness over the plurality of search target layers that maximizes the photovoltaic power as the optimal multilayer film structure, using the search parameter space in which the position of the low-dimensional space in which the plurality of corresponding points corresponding to the plurality of refractive index spectra after the dimensional compression are distributed and the thickness are included in the search parameters, with respect to the plurality of search target layers constituting the multilayer film. Here, the search unit 60 iterates the calculation processing of calculating the value of the evaluation function of the photovoltaic power by performing the optical simulation based on the specific combination of the composition and the thickness corresponding to the candidate point in the search parameter space until a predetermined iteration end condition is satisfied while updating the candidate point.

As the evaluation function according to the present embodiment, a current density corresponding to photovoltaic power is used. First, based on an any incident angle and wavelength of sunlight and a multilayer film structure (composition and thickness of each search target layer), the search unit 60 calculates a ratio of absorption by the PV1 and a ratio of incidence on the PV2 through the multilayer film by optical simulation using the method of Non-patent Literature 1. Next, the search unit 60 defines a solar spectrum, a device environment, and the like, and calculates an evaluation function value corresponding to the current density based on the defined solar spectrum and device environment and the calculated ratio of absorption by PV1 and ratio of incidence on PV2.

The optical simulation will be specifically described. As described in Non-patent Literature 1, by using the incident angle θ₀ [degree] of light incident on the multilayer film, the wavelength λ [nm] of light, and the refractive index (complex number) and the thickness [nm] of each layer corresponding to the wavelength λ, the ratio of light absorbed in each layer can be obtained. When aₗ(λ) is an absorption ratio of light at a wavelength λ [nm] of the l-th layer, r(λ) is a ratio of light reflected from the multilayer film at the wavelength λ [nm], and t(λ) is a ratio of light transmitted from the multilayer film at the wavelength λ [nm], a relationship represented by the following Expression (1) holds for aₗ(λ), r(λ), and t(λ).

$$r ( λ ) + t ( λ ) + {\sum }_{l = 1}^{L} {a}_{l} ( λ ) = 1 \qquad ( 1 )$$

As an example, the current density corresponding to the photovoltaic power is calculated using the ratio a₄(λ) of light absorbed by PV1 and the ratio t(λ) of light incident on PV2. E₁, which is a current density [mA/cm²] in PV1 per unit area, is expressed by the following Expression (2). s (λ) is a solar current density spectrum [mA/cm²/nₘ] at a wavelength λ [nm], and e₁(λ) is conversion efficiency [%/100] at the wavelength λ [nm] of PV1. λₘᵢₙ is a minimum value of the wavelength, λₘₐₓ is a maximum value of the wavelength, and a range from λₘᵢₙ to λₘₐₓ represents the wavelength range. For example, the wavelength range is set to 300 nm to 1000 nm or the like.

$${E}_{1} = {\sum }_{λ = {λ}_{min}}^{{λ}_{max}} {a}_{4} ( λ ) s ( λ ) {e}_{1} ( λ ) \qquad ( 2 )$$

E₂, which is a current density [mA/cm²] in PV2 per unit area, is expressed by the following Expression (3). e₂(λ) is conversion efficiency [%/100] at the wavelength λ [nm] of PV2.

$${E}_{2} = {\sum }_{λ = {λ}_{min}}^{{λ}_{max}} t ( λ ) s ( λ ) {e}_{2} ( λ ) \qquad ( 3 )$$

The sum of E₁ in Expression (2) and E₂ in Expression (3), E₁+E₂, means a current density corresponding to the photovoltaic power. The search unit 60 calculates E₁+E₂ as an evaluation function value. The search unit 60 searches for one point, as an optimal point, on the search parameter space expressed by a 20 dimensional continuous value at which the evaluation function value is maximum. For example, optimization can be realized by using black box optimization such as Bayesian optimization, group intelligence, or an evolutionary algorithm.

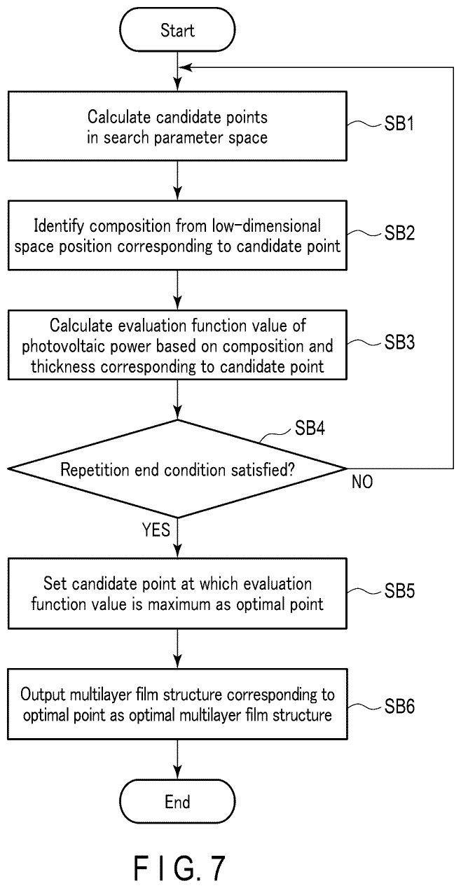

FIG. 7 is a diagram illustrating a processing example related to the optimization of the multilayer film structure by the search unit 60. As illustrated in FIG. 7, the search unit 60 calculates a candidate point in the search parameter space (step SB1). One candidate point in the search parameter space designates a position within a continuous value range and/or a position within a continuous value range of a thickness in a low-dimensional space for each of all search target layers. A method of calculating the candidate point is not particularly limited, and the candidate point may be calculated according to an algorithm corresponding to the type of black box optimization described above.

When step SB1 is performed, the search unit 60 identifies the composition from the low-dimensional space position corresponding to the candidate point calculated in step SB1 (step SB2). There are roughly two types of methods for identifying the composition from the low-dimensional space position. The composition is identified for each search target layer.

The first identification method of identifying a composition: The search unit 60 calculates a corresponding point closest to a position corresponding to a candidate point in a low-dimensional space among a plurality of corresponding points in the low-dimensional space, and identifies a composition corresponding to the calculated corresponding point as a composition corresponding to the candidate point.

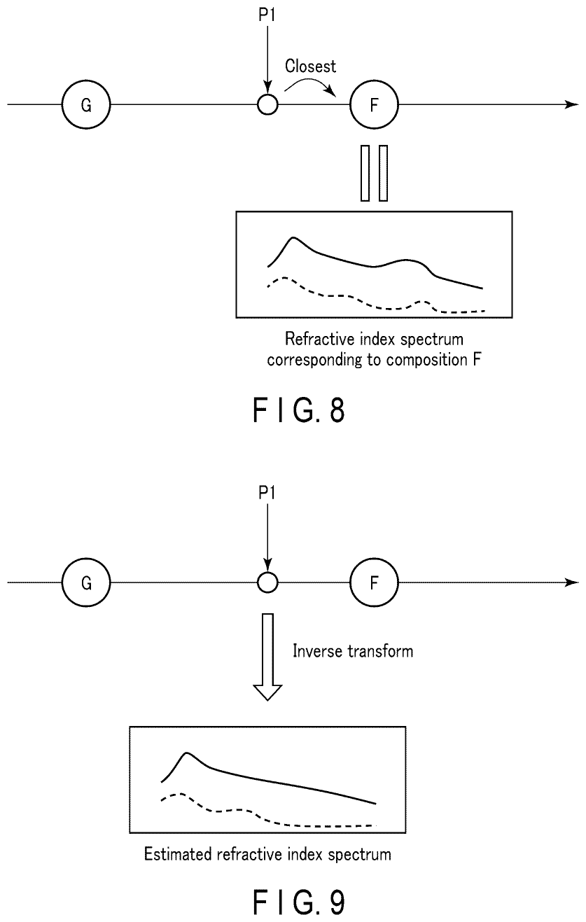

FIG. 8 is a diagram schematically showing a first identification method of identifying a composition. As illustrated in FIG. 8, it is assumed that the corresponding point of the composition G and the corresponding point of the composition F are distributed in the low-dimensional space, and the candidate point P1 exists between the corresponding point of the composition G and the corresponding point of the composition F. The search unit 60 calculates a distance in the low-dimensional space between each of the plurality of corresponding points distributed in the low-dimensional space and the candidate point P1, and identifies a corresponding point closest to the candidate point P1 based on the calculated distance. Then, the search unit 60 identifies the type of composition and/or the refractive index spectrum corresponding to the identified corresponding point as the composition corresponding to the candidate point P1. For example, in FIG. 8, the type and/or refractive index spectrum of the composition F corresponding to the corresponding point (F) closest to the candidate point P1 is identified as the composition corresponding to the candidate point P1.

The second identification method of identifying a composition: The expansion unit 50 performs inverse transform of dimensional compression on a position corresponding to a candidate point in a low-dimensional space to calculate an estimated refractive index spectrum. The search unit 60 identifies the calculated estimated refractive index spectrum as a composition corresponding to the candidate point.

FIG. 9 is a diagram schematically showing a second identification method of identifying the composition. The expansion unit 50 performs inverse transform of dimensional compression on the low-dimensional space position corresponding to the candidate point P1 to calculate the estimated refractive index spectrum corresponding to the candidate point P1. For example, when the low-dimensional space position corresponding to the candidate point P1 is “0”, in FIG. 9, the composition that is located between the composition G and the composition F, and is closest to the candidate point P1 is the composition F. In the second method, the expansion unit 50 restores the estimated refractive index spectrum by multiplying the low-dimensional space position “0” by the first principal component vector. It is assumed that the estimated refractive index spectrum has a shape close to the refractive index spectrum of the composition F between the refractive index spectrum of the composition G and the refractive index spectrum of the composition F. The search unit 60 identifies the estimated refractive index spectrum as a composition corresponding to the candidate point P1.

When step SB2 is performed, the search unit 60 calculates an evaluation function value of the photovoltaic power based on the composition and the thickness corresponding to the candidate point (step SB3). The composition is identified in step SB2. The thickness is identified before step SB3. The search unit 60 may identify a continuous value of the thickness corresponding to the candidate point. The thickness is identified for each search target layer. Then, the search unit 60 performs the above optical simulation based on the composition and the thickness for all the search target layers and calculates an evaluation function value E₁+E₂ of photovoltaic power. When the estimated refractive index spectrum is identified as the composition, the search unit 60 may perform optical simulation and calculation of the evaluation function value using the estimated refractive index spectrum. The calculated evaluation function value is stored in the storage device 2 in association with the corresponding candidate point.

When step SB3 is performed, the search unit 60 determines whether an iteration end condition is satisfied (step SB4). The iteration end condition can be set in any condition. The iteration end condition may be set to, for example, that the evaluation function value has reached a predetermined value, that the number of iterations has reached a predetermined number of times, or the like. The predetermined value and the predetermined number of times can be set to any value.

In a case where it is determined in step SB4 that the iteration end condition is not satisfied (step SB4: YES), the search unit 60 updates the candidate point according to the optimization algorithm (step SB1), and iterates steps SB2 to SB4 for the updated candidate point.

In a case where it is determined in step SB4 that the iteration end condition is satisfied (step SB4: YES), the search unit 60 sets the candidate point having the maximum evaluation function value as the optimal point (step SB5). As an example, the search unit 60 identifies a maximum value from among a plurality of evaluation function values calculated up to the current number of iterations, and sets a candidate point associated with the identified maximum evaluation function value as an optimal point.

When step SB5 is performed, the search unit 60 outputs the multilayer film structure corresponding to the optimal point set in step SB5 as an optimal multilayer film structure (step SB6). Specifically, the search unit 60 outputs a combination of the composition and the thickness for each search target layer corresponding to the optimal point as an optimal multilayer film structure. The composition of each search target layer can be identified as the type of composition and/or the refractive index spectrum of the composition in the case of using the first identification method illustrated in FIG. 8, and can be identified as the estimated refractive index spectrum in the case of using the second identification method illustrated in FIG. 9. Data of the optimal multilayer film structure is stored in the storage device 2.

When step SB6 is performed, the processing related to the optimization of the multilayer film structure by the search unit 60 according to step SA6 ends.

As illustrated in FIG. 2, when step SA6 is performed, the display control unit 70 displays the optimal multilayer film structure output in step SA6 on the display device 4 (step SA7). By displaying the optimal multilayer film structure, the operator can grasp the optimal multilayer film structure. The display layout of the optimal multilayer film structure can be set in any manner. For example, the display control unit 70 displays, in a schematic diagram, types of compositions and continuous values of the thicknesses of a plurality of search target layers constituting an optimal multilayer film structure.

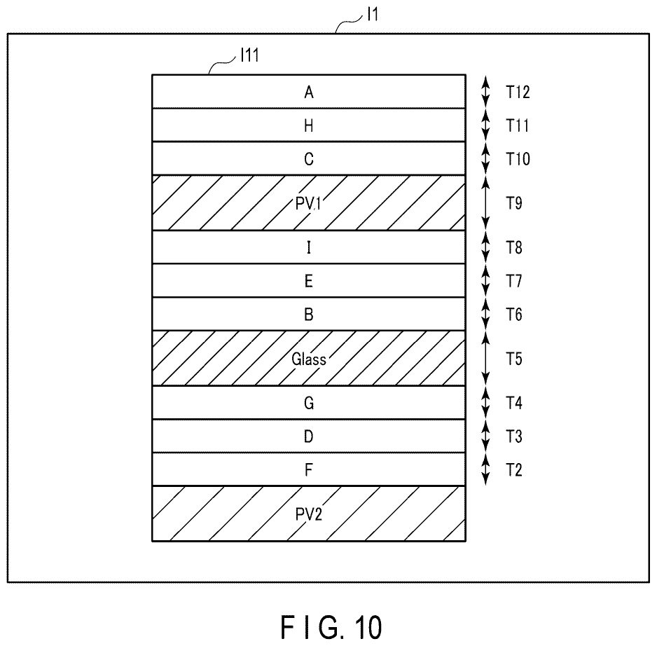

FIG. 10 is a diagram illustrating an example of a schematic diagram of a multilayer film representing an optimal multilayer film structure. As illustrated in FIG. 10, a schematic diagram I11 of a multilayer film (tandem solar cell) showing an optimal multilayer film structure is displayed on the display screen I1. In the example of FIG. 10, it is assumed that the type of optimal composition is identified for each layer. A label such as “A” which is a type of composition is superimposed on each layer in the schematic diagram I11. “T2” or the like, which is a continuous value of the thickness, is displayed adjacent to each layer in the schematic diagram I11. When the thickness is zero, it means that the optimal solution is to delete the layer. As described above, by displaying the optimal multilayer film structure in a schematic diagram or the like, the operator can intuitively grasp the optimal multilayer film structure.

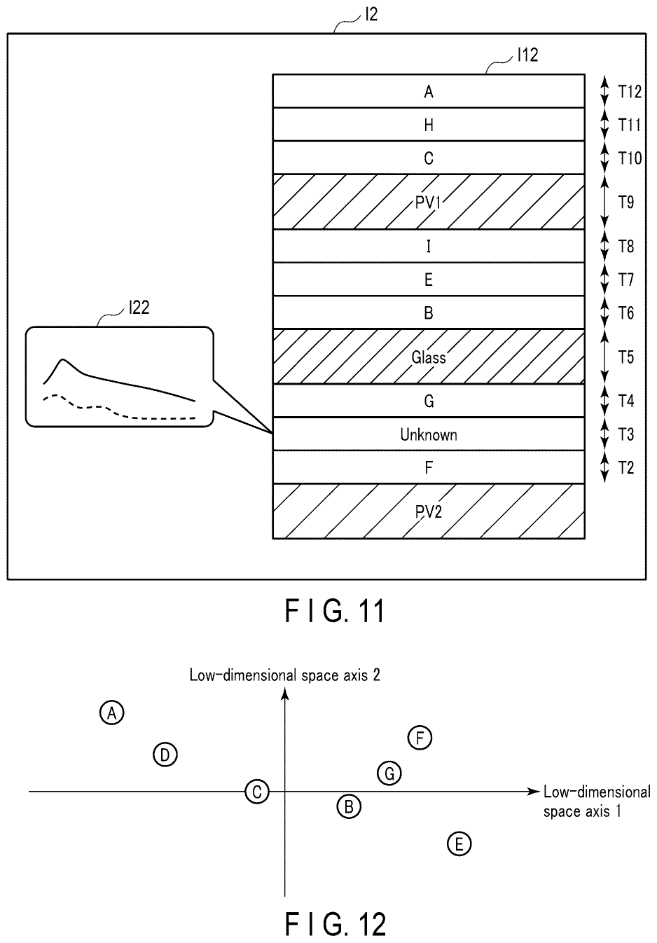

FIG. 11 is a diagram illustrating another example of a schematic diagram of a multilayer film representing an optimal multilayer film structure. As illustrated in FIG. 11, a schematic diagram I21 of a multilayer film (tandem solar cell) showing an optimal multilayer film structure is displayed on the display screen 12. In the example of FIG. 11, it is assumed that the estimated refractive index spectrum is identified as the optimal composition for the third thin film layer from the bottom. For the other layers, as in FIG. 10, it is assumed that the type of composition is identified as the optimal composition. A label such as “unknown” indicating that the type of composition is unknown is superimposed on the third thin film layer in schematic diagram I21. For example, when the operator selects the third thin film layer via the input device 3, the display control unit 70 displays a window I22 representing the estimated refractive index spectrum associated with the selected thin film layer. Note that, in a case where the estimated refractive index spectrum is obtained by an 1802 dimensional real number vector, the display control unit 70 may convert the estimated refractive index spectrum into a complex vector by matching the horizontal axes of the real part and the imaginary part using the rule that the 1 to 901 dimension is the real part and the 902 to 1802 dimension is the imaginary part. As described above, by displaying the estimated refractive index spectrum as the optimal composition that is not registered in the composition DB, it is expected that the operator is made aware of the composition candidate that has not been considered so far, leading to support of selection of the composition.

Note that the display control unit 70 may display the image of the refractive index spectrum associated with the layer when the layer on which the label indicating the type of composition is superimposed is selected via the input device 3. In addition, the display form of the optimal multilayer film structure is not limited to the schematic diagram, and may be displayed in a tabular form. In the case of the tabular form, the display control unit 70 may display, for example, the type of composition or the estimated refractive index spectrum and the continuous value of the thickness for each search target layer in a list.

As described above, the processing related to the design of the multilayer film structure by the processor 1 ends.

Note that the processing example illustrated in FIG. 2 is an example, and various types of processing can be added, deleted, and/or changed. As an example, the setting of the search space (SA1) and/or the construction of the composition DB (SA2) may be performed by an external computer. In this case, the acquisition unit 30 may acquire the data of the search space and the composition DB from the external computer via the communication device 5. As another example, the display (SA7) of the optimal multilayer film structure can be omitted. In this case, the data of the optimal multilayer film structure may be stored in the storage device 2 or may be transferred to another computer via the communication device 5. As another example, the setting unit 10 may set the composition of the bottom solar cell layer (PV2) and/or the top solar cell layer (PV1) as the search target, and the search unit 60 may search for the composition of the bottom solar cell layer (PV2) and/or the top solar cell layer (PV1).

According to the above embodiment, the multilayer film design apparatus 100 includes at least the compression unit 40 and the search unit 60. The compression unit 40 dimensionally compresses a plurality of refractive index spectra representing refractive indexes for respective wavelengths corresponding to a plurality of composition candidates of each of a plurality of layers constituting the multilayer film. The search unit 60 searches for a combination of a composition and a thickness over a plurality of layers that maximizes photovoltaic power as an optimal multilayer film structure, using a search parameter space in which a position of a low-dimensional space in which a plurality of points corresponding to the plurality of refractive index spectra after dimensional compression is distributed and a thickness are included in search parameters, for each of the plurality of layers.

According to the above configuration, the composition as the search parameter is not treated as a discrete category value representing the type of composition, but treated as the position of the low-dimensional space in which the refractive index spectrum of the composition is dimensionally compressed and the refractive index spectrum after the dimensional compression is distributed. Since the category value has no continuity, when the composition is searched for using the category value, it takes a lot of processing time to exhaustively execute the optical simulation and calculate the evaluation function value for all the composition candidates, or an optimization algorithm such as black box optimization is used while allowing poor accuracy. On the other hand, since the low-dimensional space retains some characteristic of the refractive index spectrum, the low-dimensional space position has continuity in the context of the refractive index spectrum. Therefore, the search unit 60 can execute an optimization algorithm using a low-dimensional space position, which is a continuous value, as a search parameter, and is only required to execute optical simulation and calculate an evaluation function value only for candidate points determined by the algorithm. As a result, it is possible to reduce the processing amount, shorten the processing time, reduce the memory usage, and the like regarding the execution of the optical simulation and the calculation of the evaluation function value, and it is possible to obtain the optimal solution of the composition with high accuracy. As a result, the multilayer film structure can be designed with high efficiency and high performance.

The above embodiment is an example, and it is possible to add, delete, and/or change various elements and/or processes without departing from the gist of the invention.

### <First Modification>

The compression unit 40 according to the above embodiment uses the principal component analysis of the real number vector as the dimensional compression method of the refractive index spectrum. However, the compression unit 40 according to the present embodiment may treat the refractive index spectrum as a complex vector of a real part and an imaginary part and perform complex principal component analysis on the refractive index spectrum. As a dimensional compression method, the compression unit 40 may use AutoEncoder, tSNE, UMAP, or any other methods.

### <Second Modification>

The compression unit 40 according to the above embodiment approximates the type of composition with a continuous value using only the first principal component of the principal component analysis. However, as the type of the composition DB is more complicated, it may be difficult to simply express the type of composition with only one axis (first principal component). The compression unit 40 according to the present embodiment may express the type of composition by the multidimensional continuous value. In this case, the search dimension increases, but the composition information can be handled more flexibly by extending the continuous value space representing the type of composition to multiple dimensions.

FIG. 12 is a diagram illustrating a low-dimensional space according to the second modification. As illustrated in FIG. 12, the low-dimensional space according to the second modification is a two-dimensional continuous value space. For example, the axis 1 is defined as a first principal component, and the axis 2 is defined as a second principal component. Even in the two-dimensional low-dimensional space, the search unit 60 can identify the composition corresponding to the candidate point by the first identification method or the second identification method.

### <Third Modification>

The solar cell according to the above embodiment is a tandem type. However, the solar cell according to the present embodiment can be applied to either a single-layer type solar cell including only a silicon power generation layer in a power generation layer or a tandem type solar cell including both a silicon power generation layer and a power generation layer having another composition in a power generation layer. The solar cell according to the present embodiment can also be applied to a type including a silicon power generation layer and a plurality of power generation layers having another composition.

### <Fourth Modification>

The search unit 60 according to the above embodiment solves the optimal multilayer film structure only once. However, the present embodiment is not limited to this. After the optimal multilayer film structure is searched for by the search unit 60, the setting unit 10 according to the fourth modification resets the search parameter space according to the optimal multilayer film structure. Here, the setting unit 10 deletes the layer in which the optimal value of the thickness is set to a zero value, and increases the number of layers adjacent to the layer in which the optimal value of the thickness is set to a value other than the zero value. The search unit 60 searches for an optimal multilayer film structure again according to the reset search parameter space. As a result, the number of layers can also be optimized.

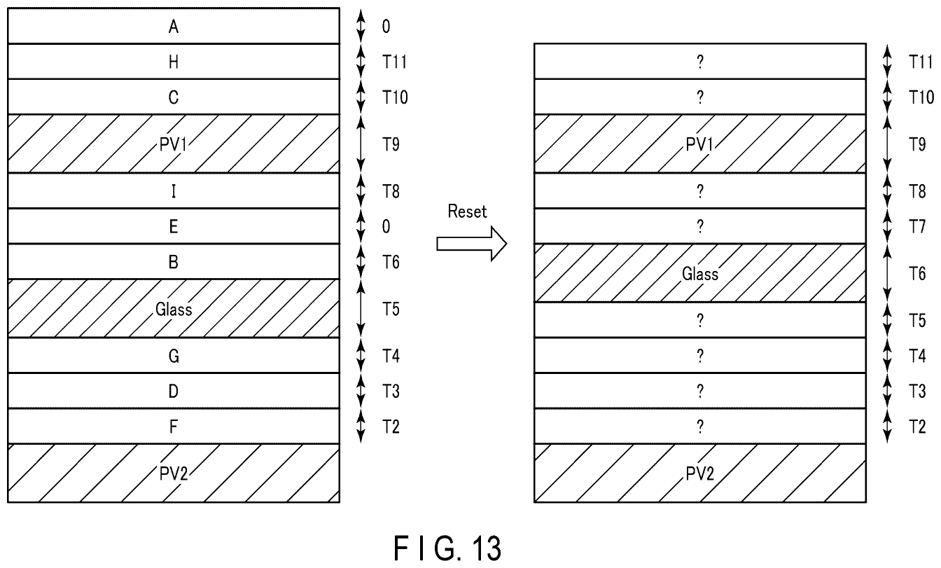

FIG. 13 is a diagram schematically illustrating resetting of a search parameter space according to the fourth modification. The left diagram in FIG. 13 is a schematic diagram illustrating an optimal multilayer film structure in the first iteration. As shown in the left diagram of FIG. 13, it is assumed that the thicknesses of the seventh layer of the composition “E” and the twelfth layer of the composition “A” are zero, and the thicknesses of three layers between the layer of the bottom solar cell “PV2” and the substrate layer of “Glass”, that is, the first layer of the composition “F”, the second layer of “D”, and the third layer of “G” are all non-zero.

The setting unit 10 resets the search parameter space in the second iteration based on the optimal multilayer film structure in the first iteration. Specifically, the setting unit 10 deletes the seventh layer of the composition “E” and the twelfth layer of the composition “A”, which have a zero thickness. In addition, the setting unit 10 adds one layer adjacent to the three layers of compositions “F”, “D”, and “G” having a non-zero thickness. The number of layers to be increased is not limited to one layer, and two or more layers may be added. The layer to be added may be designated by an operator's instruction via the input device 3. The setting unit 10 may assign an optimal value of the search in the first iteration as an initial value of the composition and the thickness of each layer, or may assign any other values. In this way, the search parameter space is reset. Thereafter, the search unit 60 searches for an optimal multilayer film structure again according to the reset search parameter space.

### <Fifth Modification>

The search unit 60 according to the above embodiment solves the optimal multilayer film structure only once. On the other hand, it is preferable that the composition candidates are sufficient without excess or deficiency. When the number of composition candidates is too large, the search time increases, and when the number of composition candidates is too small, the number of search options decreases, and the accuracy is deteriorated. After the optimal multilayer film structure is searched for by the search unit 60, the construction unit 20 according to the fifth modification reconstructs the composition DB according to the optimal multilayer film structure. Here, the construction unit 20 includes a refractive index spectrum similar to the refractive index spectrum corresponding to the optimal position in the low-dimensional space in the composition DB. The search unit 60 searches for an optimal multilayer film structure again according to the reconstructed composition DB. This makes it possible to efficiently search for the multilayer film structure.

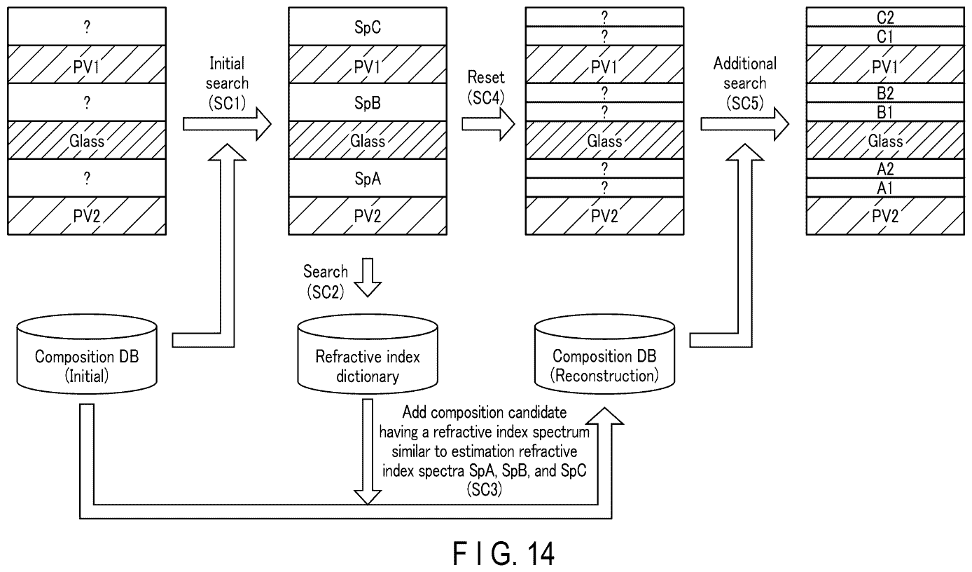

FIG. 14 is a diagram schematically illustrating a processing example related to the design of the multilayer film structure according to the fifth modification. As illustrated in FIG. 14, first, the search unit 60 executes an initial search according to the initial composition DB (step SC1). In the initial search, the setting unit 10 makes the number of layers of the search target layer smaller than that in the above embodiment. For example, the number of thin films to be mounted on each of the top solar cell layer (PV1), the glass substrate layer (Glass), and the bottom solar cell layer (PV2) is set to one layer. For example, the construction unit 20 registers only a small number of composition candidates having significantly different characteristics of the refractive index spectrum in the initial composition DB. In the initial search, the search unit 60 identifies the estimated refractive index spectrum that is the composition of each search target layer by the second identification method. An initial optimal structure is obtained by an initial search. As the composition of each search target layer, an estimated refractive index spectrum labeled with “SpA”, “SpB”, “SpC”, or the like is obtained as the optimal composition.

The construction unit 20 searches the refractive index dictionary, and extracts a composition candidate having a refractive index spectrum similar to the estimated refractive index spectrum of each search target layer (step SC2). Then, the construction unit 20 adds the category value of the extracted composition candidate and the data of the refractive index spectrum of the composition candidate to the composition DB (step SC3). As a result, the composition DB is reconstructed. Data of the reconstructed composition DB is stored in the storage device 2.

The setting unit 10 resets the search parameter space using the reconstructed composition DB (step SC4). Specifically, first, the setting unit 10 adds another layer adjacent to the layer in which the optimal value of the thickness is non-zero in the initial search, and sets a layer other than PV2 as the search target layer. Then, the setting unit 10 sets a continuous value range of the thickness of each search target layer. In addition, the compression unit 40 performs dimensional compression on all the refractive index spectra included in the composition DB, and the setting unit 10 sets a continuous value range in a low-dimensional space in which the refractive index spectra after the dimensional compression are distributed. The search parameter space is reset by setting the continuous value range of the thickness of each search target layer and the continuous value range of the low-dimensional space. Then, the search unit 60 searches for an optimal multilayer film structure again using the search parameter space after resetting (step SC5). As described above, the processing related to the design of the multilayer film structure according to the fifth modification is performed.

According to the fifth modification, the number of composition candidates is reduced in the initial optimization, and a composition candidate having a refractive index spectrum similar to the estimated refractive index spectrum obtained in the initial optimization is added in the next optimization. This makes it possible to efficiently optimize the multilayer film structure. Furthermore, by reducing the number of search target layers in the initial optimization, it is possible to further shorten the time required for overall optimization.

### <Sixth Modification>

In the above embodiment, the first identification method and the second identification method can be selectively used as the composition identification method. However, the present embodiment is not limited thereto. For example, only the first identification method may be used as the composition identification method. In this case, the mounting of the expansion unit 50 can be omitted.

### <Seventh Modification>

The evaluation function according to the above embodiment includes only the current density corresponding to the photovoltaic power. However, the present embodiment is not limited thereto. As an example, the evaluation function according to the seventh modification may include a term in consideration of the procurement cost of the selected composition, the manufacturing cost proportional to the thickness, and the like.

Thus, according to the above embodiment, it is possible to provide a multilayer film design apparatus, a method, and a storage medium capable of designing a multilayer film structure with high efficiency and high performance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A multilayer film design apparatus comprising: a processing circuit configured to
dimensionally compress a plurality of refractive index spectra representing refractive indexes for respective wavelengths corresponding to a plurality of composition candidates, and
search, for each of a plurality of layers constituting a multilayer film, a combination of a composition and a thickness over the layers that maximizes photovoltaic power as an optimal multilayer film structure using a search parameter space, the search parameter space including, as search parameters, a position of a low-dimensional space in which a plurality of points corresponding to the refractive index spectra after dimensional compression is distributed and a thickness of each layer.

2. The multilayer film design apparatus according to claim 1, wherein the processing circuit iterates calculation processing of calculating a value of an evaluation function of photovoltaic power by performing optical simulation based on a specific combination of a composition and a thickness corresponding to a candidate point of the search parameter space until a predetermined condition is satisfied while updating the candidate point.

3. The multilayer film design apparatus according to claim 2, wherein the processing circuit calculates a point closest to a position corresponding to the candidate point in the low-dimensional space among the points in the low-dimensional space, and identifies a composition corresponding to the calculated point as a composition corresponding to the candidate point.

4. The multilayer film design apparatus according to claim 2,
wherein the processing circuit is further configured to:
calculate an estimated refractive index spectrum by performing inverse transform of the dimensional compression on a position corresponding to the candidate point in the low-dimensional space, and
identify the estimated refractive index spectrum as a composition corresponding to the candidate point.

5. The multilayer film design apparatus according to claim 2, wherein the processing circuit is further configured to calculate an estimated refractive index spectrum by performing inverse transform of the dimensional compression on a position corresponding to the candidate point in the low-dimensional space.

6. The multilayer film design apparatus according to claim 5, wherein the processing circuit is further configured to display the estimated refractive index spectrum on a display device.

7. The multilayer film design apparatus according to claim 5, wherein the processing circuit performs the optical simulation using the estimated refractive index spectrum as a composition related to the specific combination.

8. The multilayer film design apparatus according to claim 1, wherein the processing circuit is further configured to display the optimal multilayer film structure on a display device.

9. The multilayer film design apparatus according to claim 8, wherein the processing circuit displays types of compositions and thicknesses of the layers constituting the optimal multilayer film structure in a schematic diagram or a tabular form of the multilayer film.

10. The multilayer film design apparatus according to claim 1, wherein the processing circuit is further configured to set the search parameter space including a continuous value range of the low-dimensional space and/or a continuous value range of the thickness.

11. The multilayer film design apparatus according to claim 10, wherein the processing circuit includes a zero value in a continuous value range of the thickness.

12. The multilayer film design apparatus according to claim 10,
wherein the processing circuit is configured to:
reset, after the optimal multilayer film structure is searched, the search parameter space according to the optimal multilayer film structure, a layer in which an optimal value of the thickness is set to a zero value being deleted, and increases the number of layers adjacent to a layer in which the optimal value of the thickness is set to a value other than the zero value, and
search the optimal multilayer film structure again according to the reset search parameter space.

13. The multilayer film design apparatus according to claim 1, wherein the processing circuit is further configured to construct a composition database in which the composition candidates and the refractive index spectra are associated with each other.

14. The multilayer film design apparatus according to claim 13,
wherein the processing circuit is configured to:
reconstruct, after the optimal multilayer film structure is searched, the composition database according to the optimal multilayer film structure, a refractive index spectrum similar to a refractive index spectrum corresponding to an optimal position in the low-dimensional space being included in the composition database, and
search the optimal multilayer film structure again according to the reconstructed composition database.

15. The multilayer film design apparatus according to claim 1, wherein the multilayer film is stacked on a silicon power generation layer included in a solar cell.

16. The multilayer film design apparatus according to claim 15, wherein the solar cell is a single-layer type including only the silicon power generation layer in a power generation layer, or a tandem type including both the silicon power generation layer and a power generation layer having another composition in a power generation layer.

17. A computer-implemented multilayer film design method comprising:
dimensionally compressing a plurality of refractive index spectra representing refractive indexes for respective wavelengths corresponding to a plurality of composition candidates, and
searching, for each of a plurality of layers constituting a multilayer film, a combination of a composition and a thickness over the layers that maximizes photovoltaic power as an optimal multilayer film structure using a search parameter space, the search parameter space including, as search parameters, a position of a low-dimensional space in which a plurality of points corresponding to the refractive index spectra after dimensional compression is distributed and a thickness of each layer.

18. A non-transitory computer readable medium including computer executable instructions, wherein the instructions, when executed by a processor, cause the processor to perform operations comprising:
dimensionally compressing a plurality of refractive index spectra representing refractive indexes for respective wavelengths corresponding to a plurality of composition candidates, and
searching, for each of a plurality of layers constituting a multilayer film, a combination of a composition and a thickness over the layers that maximizes photovoltaic power as an optimal multilayer film structure using a search parameter space, the search parameter space including, as search parameters, a position of a low-dimensional space in which a plurality of points corresponding to the refractive index spectra after dimensional compression is distributed and a thickness of each layer.
